(19) United States
(12) Patent Application Publication
(10) Pub. No.: US 2010/0247267 A1
(43) Pub. Date: Sep. 30, 2010

(54) Method for anchoring a fastening element in a mineral component, and fastening element for mineral components

(75) Inventors: Pietro Bianchi, Gams (CH); Bernhard Sander, Muenchen (DE); Falk Rosenkranz, Wildhaus (CH); Peter Gstach, Schaan (LI); Georg Oberndorfer, Feldkirch (AT); Bernhard Winkler, Feldkirch (AT)

Correspondence Address: Davidson, Davidson & Kappel, LLC, 485 7th Avenue, 14th Floor, New York, NY, 10018, US

(73) Assignee: Hilti Aktiengesellschaft, Schaan (LI)

(21) Appl. No.: 12/661,711

(22) Filed: Mar. 23, 2010

(30) Foreign Application Priority Data
Mar. 24, 2009 (DE) DE102009001815.8

(51) Int. Cl. F16B 25/02

(52) U.S. Cl. 411/387.4

(57) ABSTRACT

A method is described for anchoring a fastening element (11) in a mineral component (1), in which a bore hole (2) is provided in the component (1) using a drill bit having a nominal drill bit diameter, and a fastening element (11) is then screwed into the provided bore hole (2). The fastening element (11) has a shank (12) which is provided with rotary engagement device (16) for a setting tool, and has a core diameter (K) and cutting edges (21) on a first end region. The fastening element has a self-tapping thread (17) in which the difference between the outer diameter of the thread (17) and the core diameter (K) of the shank (12) corresponds to 0.05 to 0.7 times the pitch of the thread (17). A drill bit is used which has a nominal drill bit diameter corresponding to 0.95 to 1.10 times the core diameter (K) of the shank (12). Also described is a fastening element (11) for anchoring in a mineral component (1).

This claims the benefit of German Patent Application No. DE 10 2009 001815, filed Mar. 24, 2009 and hereby incorporated by reference herein.

The present invention relates to a method for anchoring a fastening element in a mineral component. The present invention further relates to a fastening element for mineral components.

### BACKGROUND

For anchoring a fastening element in a mineral component or substrate composed of concrete or masonry, for example, first a bore hole is provided in the component with the aid of a drill bit which has a nominal drill bit diameter, and a fastening element is then screwed into the bore hole produced. The fastening element has a shank which is provided with rotary engagement means or device for a setting tool and has a core diameter, as well as a self-tapping thread whose outer diameter is greater than the inner diameter of the bore hole.

When the fastening element is screwed into the bore hole, the turns of the thread cut or press into the bore hole wall in the mineral component, thus anchoring the fastening element via the undercut provided in the bore hole for transmitting loads.

The fastening element is designed, for example, as a screw having a hexagonal head or a square socket as rotary engagement means at one end of the shank. Alternatively, the fastening element is an internally threaded sleeve, for example, having interior rotary engagement means with a self-tapping thread on the exterior of the shank.

In mineral components or substrates, the transmittable shear forces are much smaller than the transmittable compressive forces, for which reason thread cutters for metal are unsuitable for use in mineral components. Self-tapping fastening elements for mineral substrates have a thread in which a difference between the outer diameter of the thread and the core diameter of the shank corresponds to 0.05 to 0.7 times the pitch of the thread. This type of self-tapping concrete screw as a fastening element for mineral components is known from EP 0 697 071 B1, for example.

The design of generic fastening elements results in conflicting requirements for settability and load-bearing capacity. For the settability it is advantageous when the core diameter of the shank is kept small. For the load-bearing capacity it is advantageous when the core diameter of the shank is designed to be as large as possible.

With increasing bore hole depth and increasing wear on the drill bit, the provided bore hole has a much smaller inscribed bore cylinder (IBC) than the nominal drill bit diameter of the drill bit used. The inscribed bore cylinder (IBC) is the circular cylinder of the largest diameter which may be inserted into the bore hole produced by the drill bit without further auxiliary means, and thus without great resistance, to the intended anchoring depth of the fastening element. For this reason, during drilling a bore hole is often provided which is too narrow for the core diameter of the shank, i.e., has negative axial deviations. Since the fastening element is not able to adapt to the inscribed bore cylinder, i.e., to the bore hole having negative axial deviations, the fastening element is difficult or impossible to set.

To assist in cutting a thread in a mineral substrate and to improve the settability of a self-tapping fastening element for mineral components, even for a bore hole that is narrowed in places, a self-tapping concrete screw is known from EP 0 560 789 B1 which has a cutting edge on a first end region of the shank.

A disadvantage of the known approach is that, despite the improved setting characteristics compared to a conventional concrete screw as known from EP 0 697 071 B1, for example, the load-bearing capacity of the concrete screw according to EP 0 560 789 B1 is not increased.

A self-tapping fastening element for mineral components is known from EP 1 795 768 B1 which has four grooves on its free front end, viewed in the setting direction, for receiving the drill dust resulting from cutting the counterthread. These grooves prevent the drill dust from clogging the interspace between the bore hole wall and the shank. This reduces the tightening torque for setting the fastening element. For a bore hole which has been produced using a partially worn drill bit, or which has a large bore hole depth, the settability of this self-tapping fastening element is not improved as a result of the grooves. For this self-tapping fastening element, force is transmitted essentially via the drill dust compressed between the bore hole wall and the shank. However, it cannot be ensured that continuous compression occurs along the lateral surface of the bore hole and thus that ideal transmission of force into the component is provided.

### SUMMARY OF THE INVENTION

An object of the present invention is to provide a method for anchoring a self-tapping fastening element for mineral components or substrates, the set fastening element having advantageous load-bearing and setting characteristics. A further object of the present invention is to provide a self-tapping fastening element for mineral components or substrates which has advantageous load-bearing and setting characteristics.

The present invention provides a method for anchoring a fastening element in a mineral component, in which a bore hole is provided in the component using a drill bit having a nominal drill bit diameter, and a fastening element is then screwed into the bore hole produced, the fastening element having a shank which is provided with rotary engagement means for a setting tool, and having a core diameter and at least one cutting edge on a first end region, and having a self-tapping thread, in which the difference between the outer diameter of the thread and the core diameter of the shank corresponds to 0.05 to 0.7 times the pitch of the thread.

According to the present invention, for providing the bore hole in the mineral component a drill bit is used which has a nominal drill bit diameter corresponding to 0.95 to 1.10 times the core diameter of the shank.

In the present context, the nominal drill bit diameter is understood to mean the size designation of the drill bit (for example, 6 mm, 8 mm, 10 mm, or ¼″, 5/16″, ⅜″, etc.). For a drill bit having a drill bit head which is symmetrical with respect to the drill bit shank, the drill bit tip, for example a cutting insert for the drill bit, has an extension which is referred to as the drill bit cross-corner width. For a drill bit having an asymmetrical drill bit head, in the present context the nominal drill bit diameter is understood to mean the diameter of the lateral surface of the bore hole produced by this drill bit. The nominal drill bit diameter and the associated minimum and maximum drill bit cross-corner width is defined, for example, in Table ETAG 001 (Guideline for European Technical Approval of Metal Anchors for Use in Concrete) in metric units, and in Table ACI 355.2-04 (American Concrete Institute) for English units.

The at least one cutting edge provided on the full core diameter ensures that the bore hole having an out-of-round or uneven cross section is adjusted to an essentially cylindrical bore hole, so that after the fastening element is set the shank comes to rest with its outer side directly against the bore hole wall. The uneven lateral surface of the bore hole is straightened when the fastening element is set. Even for a partially worn drill bit, which forms a much smaller inscribed bore cylinder (IBC) in the component or substrate, the settability of the fastening element is further ensured due to the at least one cutting edge. Thus, such a fastening element may also be set in bore holes having an inscribed bore cylinder (IBC) corresponding to 0.83 to 0.96 times the nominal drill bit diameter. The same also applies for deep bore holes, which likewise have a smaller inscribed bore cylinder (IBC) in the component or substrate in relation to the nominal drill bit diameter.

Using the method according to the present invention ensures that on the one hand any clearances are essentially completely filled by the drill dust and/or drill cuttings produced in the thread cutting, and that on the other hand the shank fully contacts a major portion of the bore hole wall. Lateral strain on the mineral material of the component in the region of the bore hole is thus prevented, resulting in modified stress states and therefore a marked increase in the concrete strength in the region of the material surrounding the bore hole. When the fastening element is set, not only is resulting drill dust collected in the groove which forms the at least one cutting edge or advanced by the fastening element, but at the same time, drill dust which is present between the shank and the bore hole wall is uniformly and highly compressed, in particular in the region of the cut counterthread.

When a drill bit is used which has a nominal drill bit diameter that is smaller than 0.95 times the core diameter of the shank, the compression of the drill dust present between the shank and the bore hole wall is too great, so that the friction in the setting process increases in such a way that it is no longer possible to set the fastening element.

When a drill bit is used which has a nominal drill bit diameter that is larger than 1.10 times the core diameter of the shank, only a small region of the exterior of the shank of the set fastening element comes into direct contact with the bore hole wall; i.e., the drill dust present between the shank and the bore hole is only slightly compressed. Although it would be possible to easily set such a fastening element, this fastening element would have a comparatively small load-bearing capacity.

The nominal drill bit diameter preferably corresponds to 0.99 to 1.08 times the core diameter of the shank, so that fastening elements in standard sizes may be advantageously set, and in the set state have particularly advantageous load-bearing characteristics.

According to the present invention, a fastening element for mineral components or substrates has a shank which has rotary engagement means for a setting tool, and a self-tapping thread in which the difference between the outer diameter of the thread and the core diameter of the shank corresponds to 0.05 to 0.7 times the pitch of the thread, at least one cutting edge being provided on a first end region of the shank, and the overall length of the at least one cutting edge parallel to the longitudinal axis of the fastening element and measured at the full core diameter corresponding at least to the pitch of the thread.

Since the at least one cutting edge has a length which is greater than the pitch of the thread, when the fastening element is screwed in with a rotation over 360° about the longitudinal axis of the fastening element the bore hole wall is circumferentially smoothed. A bore hole which is too narrow or which has negative axial deviations is partially enlarged, optionally over the entire longitudinal extension, the effort of setting the fastening element being only slightly increased compared to a conventional self-tapping fastening element. The critical factor is the length of the at least one cutting edge at the full core diameter of the shank, which corresponds at least to the pitch of a thread. The pitch of the thread corresponds to the distance covered by a complete revolution of the fastening element.

Jamming of the fastening element during setting in a bore hole having negative axial deviations is largely prevented due to the abrasive effect of the at least one cutting edge. The exterior of the shank comes into full contact with the bore hole wall over a large area, and drill dust and/or drill cuttings present in the bore hole and produced during thread-cutting are sufficiently compressed in the region of the cut counterthread.

Multiple cutting edges are preferably provided on the first end region of the shank, the summed overall length of the cutting edges parallel to the longitudinal axis of the fastening element and measured at the full core diameter corresponding at least to the pitch of the thread. The length of the individual cutting edges may be designed to be shorter than when only one cutting edge is provided, it not being necessary for the corresponding length of these cutting edges to be the same for all cutting edges. The critical factor for advantageous setting characteristics of the fastening element is the sum of the individual lengths of the cutting edges at the full core diameter of the shank, which corresponds at least to the pitch of a thread. In addition, multiple cutting edges spaced along the circumference ensure advantageous cutting characteristics when the fastening element is set or screwed into the bore hole.

It is advantageous for the cutting edges to be situated rotationally symmetrically relative to the longitudinal axis of the fastening element. When the fastening element is set, the at least two cutting edges come into contact with the mouth of the bore hole, and ensure good cutting characteristics at the start as well as during the setting process, thus allowing the fastening element to be easily set.

It is also advantageous that on the first end region of the shank an insertion section is provided which tapers toward the free end of the shank. Starting from the shank, the at least one cutting edge extends over the insertion section until reaching the free end of the shank, advantageously ending at the free end of the shank. It is particularly advantageous for the start of the self-tapping thread to be axially recessed relative to the free end of the shank, so that the at least one cutting edge is designed to be advancing relative to the thread. At the start of the setting process the at least one cutting edge prepares the mouth of the bore hole, so that when the self-tapping thread contacts the mouth of the bore hole the thread may easily cut into the substrate.

When multiple cutting edges are provided on the first end region of the shank, at least one and advantageously all of these cutting edges extend over the insertion section, thus further improving the cutting characteristics of the fastening element. The sum of the axial lengths of the cutting edges measured at the full core diameter, i.e., not including the lengths of the cutting edges on the insertion section, here as well corresponds at least to the value of the pitch of the thread. If the cutting edges are sections of grooves provided in the core of the shank, the base of the groove advantageously extends parallel to the longitudinal axis of the shank, at least in the region of the tapering insertion section.

The at least one cutting edge, or for multiple cutting edges, at least one of the cutting edges, advantageously extends, at least in places, perpendicular to the pitch or to a turn of the thread, which ensures advantageous cutting characteristics when the fastening element is set. Thus, the at least one cutting edge extends, at least in places, at an angle to a projection of the longitudinal axis. For determining the length of a cutting edge which is inclined with respect to the projection of the longitudinal axis, the length of this cutting edge projected on the longitudinal axis is considered. During the setting process, besides machining of the bore hole wall which acts primarily in the radial direction, there is also action by an axial force component, in each case relative to the longitudinal axis of the fastening element.

In particular for rotary and percussive setting of the fastening element, for example using a tangential impact screwdriver, the setting characteristics are improved by the at least one cutting edge which is inclined in places. In addition, the at least one inclined cutting edge assists in the removal of drill dust, since the resulting drill cuttings and/or drill dust are pushed in the direction of the first end of the shank.

As an alternative to at least one cutting edge which extends, at least in places, perpendicular to the pitch of the thread, this cutting edge may also extend at an angle of −30° to +30°, particularly advantageously at an angle of −15° to +15°, relative to this normal.

The orientation of the at least one cutting edge relative to the longitudinal axis of the fastening element is advantageously discontinuous. It is particularly advantageous for the at least one cutting edge to have a section which extends paraxially and a section which extends at an angle to the projection of the longitudinal axis. By the selection of the effective length of the individual sections, the setting characteristics may be influenced corresponding to requirements or the desired performance of the fastening element.

The cutting contour of the at least one cutting edge may also influence the removal characteristics. Besides a smooth design, the at least one cutting edge may also have a toothed or undulating design, for example. If multiple cutting edges are provided on a fastening element, their designs may be the same or different.

The at least one cutting edge preferably projects radially beyond the axial projection of the core diameter of the shank, so that for advantageous removal characteristics the friction between the core diameter of the shank and the bore hole wall is further minimized.

The shank in the first end region, at least in the region of the at least one cutting edge, preferably has a core diameter which is larger than the remaining core diameter of the shank, so that the greatest proportion of the friction between the core diameter of the shank and the bore hole wall occurs essentially in this region. The region of the core diameter having the enlarged diameter has, for example, a cylindrical, barrel-shaped, or truncated cone shape, and is formed, for example, by swaging or rolling the shank during manufacture of the fastening element.

A clearance angle is preferably provided between the at least one cutting edge and the shank to provide sufficient clearance for resulting drill dust and drill cuttings. The clearance angle is preferably 1° to 30°, particularly preferably 5° to 20°, relative to a tangent to the core diameter of the shank.

The at least one cutting edge preferably has a negative rake angle, which ensures advantageous removal characteristics in brittle materials such as mineral substrates and in particular concrete. The negative rake angle is preferably 1° to 30°, particularly preferably 3° to 10°.

A radially inwardly situated discharge groove is advantageously provided adjacent to the at least one cutting edge. If the fastening element has multiple cutting edges, it is particularly advantageous to provide a discharge groove for each cutting edge, so that a sufficient volume is available for removing the drill dust or drill cuttings during the setting process. The groove or grooves is/are advantageously situated on the shank and designed in such a way that when the fastening element is set, the discharged drill dust and drill cuttings are conveyed to the free end of the shank and are thus deposited in front of the set fastening element in the direction of the base of the bore hole.

The at least one cutting edge is also advantageously provided with a bevel, thus reducing the wear on the cutting edge during the setting process. The bevel angle is preferably 1° to 30°, advantageously 5° to 15°. The width of the bevel is preferably 0.05 mm to 1 mm, advantageously 0.2 mm to 0.5 mm. The undercut of the bevel, which in the present context is understood to mean the section of the bevel extending essentially parallel to the radial cross section of the shank, is 0.1 mm to 5 mm, particularly advantageously 0.5 mm to 3 mm. In the present context, “bevel” also refers to a rounded cutting edge having a radius of preferably 0.02 mm to 1 mm, advantageously 0.05 mm to 0.5 mm. When multiple cutting edges are provided on a fastening element, each of the cutting edges may be provided with a bevel, it being possible for the bevels to have the same design or different designs.

The at least one cutting edge preferably has, at least in places, a section which is harder than the shank, thus improving the removal characteristics and greatly reducing the wear on the cutting edge. In particular for a fastening element made of stainless steel, the hardness of the shank material is usually not sufficient for cutting the thread, and therefore is also not adequate for expanding the bore hole in the mineral substrate. For example, cutting elements made of hard or hardened material are applied to or introduced into the at least one cutting edge.

The invention is explained in greater detail below with reference to exemplary embodiments.

### BRIEF DESCRIPTION OF THE DRAWINGS

FIG. 1 shows a drill bit in the side view;

FIG. 2 shows a fastening element according to the present invention in the form of a self-tapping screw, in the side view;

FIG. 3 shows a detailed view of the front end of the screw shown in FIG. 1, in an enlarged illustration;

FIG. 4 shows a cross section of the front end according to line in FIG. 3;

FIG. 5 shows a cutting edge in a section from FIG. 4;

FIG. 6 shows a bore hole produced by the drill bit according to FIG. 1;

FIG. 7 shows the fastening element illustrated in FIG. 2, in the set state;

FIG. 8 shows a perspective detailed view of the front end of a second exemplary embodiment of the fastening element according to the present invention;

FIG. 9 shows a perspective detailed view of the front end of a third exemplary embodiment of the fastening element according to the present invention;

FIG. 10 shows a perspective detailed view of the front end of a fourth exemplary embodiment of the fastening element according to the present invention;

FIG. 11 shows a detailed view of the front end of a fifth exemplary embodiment of the fastening element according to the present invention;

FIG. 12 shows a detailed view of the front end of a sixth exemplary embodiment of the fastening element according to the present invention; and

FIG. 13 shows a further fastening element according to the present invention in the form of a self-tapping internally threaded sleeve, in the side view.

Identical parts are basically provided with the same reference symbols in the figures.

### DETAILED DESCRIPTION

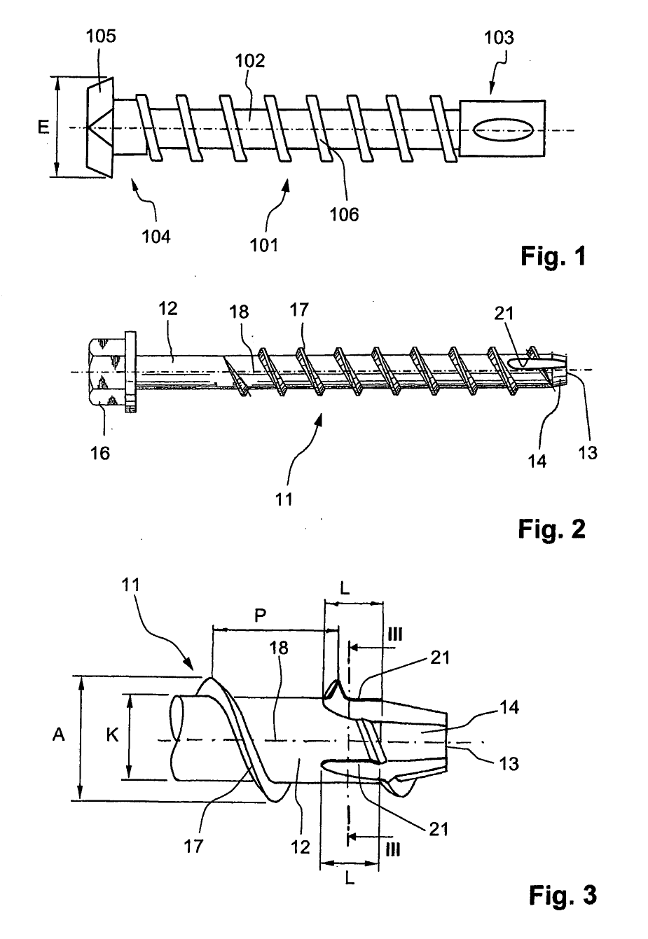

FIG. 1 shows a drill bit 101 which has a drill bit shank 102 and a nominal drill bit diameter. At one end, drill bit shank 102 is provided with an insertion end 103 for placing drill bit 101 in a drill, not illustrated. A drill bit head 104 having a plate-shaped cutting element 105 is provided at the other end of drill bit shank 102. The transverse extension of cutting element 105 defines drill bit cross-corner width E of drill bit 101. A conveying spiral 106 extends along drill bit shank 102, between drill bit head 104 and insertion end 103, for conveying the drill dust and/or drill cuttings produced during drilling from bore hole 2.

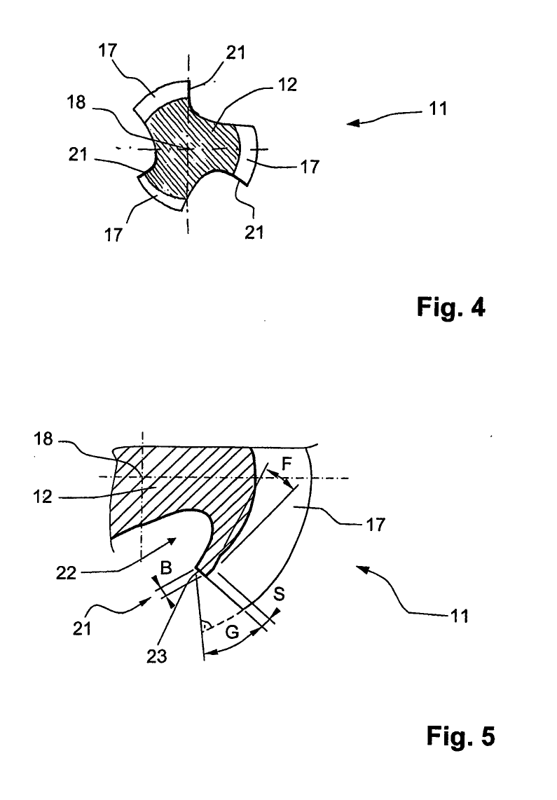

Fastening element 11 for mineral components made of concrete or masonry, for example, illustrated in FIGS. 2 through 5, is a self-tapping screw having a cylindrical shank 12. On a first free end 13, shank 12 has an insertion section 14 which tapers toward free end 13 of shank 12, and on a second end 15 has a hexagonal head as rotary engagement means 16 for a setting tool, not illustrated. Starting from an end region of first end 13, a self-tapping thread 17 extends in places along shank 12. Shank 12 defines longitudinal axis 18 of fastening element 11.

The difference between outer diameter A of thread 17 and core diameter K of shank 12 corresponds to 0.05 to 0.7 times pitch P of thread 17. Outer diameter A of thread 17 corresponds to 1.1 to 1.5 times core diameter K of shank 12. Outer diameter A of thread 17 also corresponds to 1.0 to 2.5 times pitch P of thread 17, and in particular for smaller fastening elements having a core diameter of 6 mm to 14 mm, for example, advantageously corresponds to 1.03 to 1.99 times pitch P of thread 17. For a double thread, the outer diameter of the thread advantageously corresponds to 0.5 to 1.25 times the pitch of the individual thread turns. If the thread of the fastening element has more than two thread turns, the outer diameter of this thread corresponds to (1.0 to 2.5 times the pitch of the thread) divided by the number of thread turns.

Full core diameter K is the diameter, defining the lateral surface of shank 12, from which self-tapping thread 17 projects. In this regard, any depressions or grooves provided on the shank exterior between the turns of the thread are not considered in determining full core diameter K of shank 12.

Three cutting edges 21 are provided on the first end region of shank 12, each cutting edge 21 essentially having an effective length L, extending parallel to longitudinal axis 18 of fastening element 11, for straightening the bore hole. The summed overall length of cutting edges 21 parallel to longitudinal axis 18, measured at full core diameter K, corresponds at least to pitch P of thread 17. Cutting edges 21 are situated point-symmetrically with respect to longitudinal axis 18 of fastening element 11, and starting from shank 12 extend over insertion section 14 until reaching free end 13 of shank 12. Cutting edges 21 each have a cutting contour, and radially project beyond the axial projection of core diameter K of shank 12.

A clearance angle F is provided in each case between cutting edges 21 and shank 12; in this example the clearance angle is 10°. In the present case, each cutting edge 21 also has a negative rake angle of 5°.

Adjacent to each cutting edge 21 a radial inwardly situated discharge groove 22 is provided for discharging drill dust or drill cuttings produced during setting. Cutting edges 21 are advantageously provided, at least in places, with a section which is harder than the shank, and with a bevel 23. In this exemplary embodiment bevel angle C is 10°, bevel width B is 0.4 mm, and the bevel undercut is 1 mm.

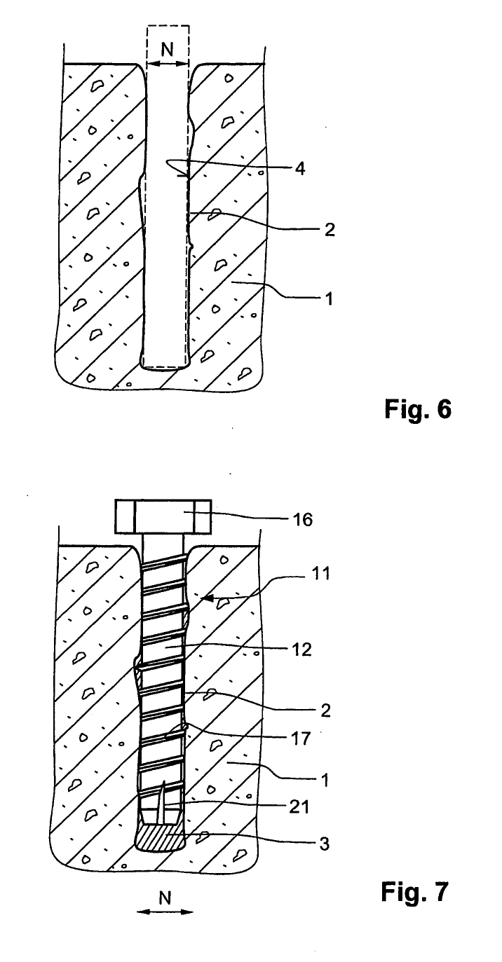

The method for setting self-tapping fastening element 11 in mineral component 1 is described below with reference to FIGS. 6 and 7, the setting process being essentially the same for the other fastening elements described below. First a bore hole 2 is drilled in component 1, using drill bit 101. Due to the bore hole depth and/or the degree of wear of drill bit 101, the provided bore hole has an inscribed bore cylinder (IBC) of smaller diameter N than the nominal drill bit diameter of drill bit 101.

Self-tapping fastening element 11 is then driven into bore hole 2 by rotation or percussion. Cutting edges 21 situated on the front end region of shank 12 smooth the out-of-round or uneven lateral surface 4 of bore hole 2 when fastening element 11 is screwed in. In the set state of fastening element 11 (see FIG. 7) the major part of the exterior or the lateral surface of shank 12 situated in the bore hole contacts lateral surface 4 of bore hole 2. Drill dust and/or drill cuttings present in the region of the cut counterthread are compressed between shank 12 and lateral surface 4 of bore hole 2.

Before driving in fastening element 11, bore hole 2 is optionally cleaned using an air pump, for example, and bore hole 2 is then filled with a specified quantity of a curable compound 3. Curable compound 3 is distributed in bore hole 2 when fastening element 11 is subsequently driven in. The removed mineral drill dust and/or drill cuttings mix with curable compound 3, thus allowing high loads to be transmitted by cured compound 3.

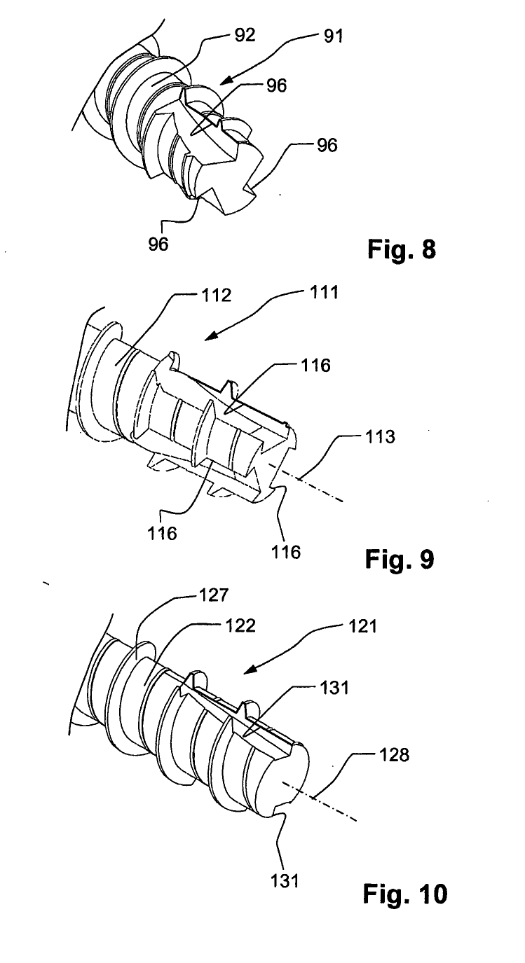

FIG. 8 shows a second specific embodiment of a self-tapping fastening element 91, having an alternatively designed cutting edge 96 which is part of a V-shaped groove which is radially outwardly open. On this fastening element 91 three cutting edges 96 are rotationally symmetrically provided on shank 92, extending starting from the free end of the shank.

FIG. 9 shows a third specific embodiment of a self-tapping fastening element 111, having an alternatively designed cutting edge 116 which is part of a U-shaped groove which is radially outwardly open. On this fastening element 111 three cutting edges 116 are provided on shank 112, starting from the free end of the shank. In this case the grooves are centrally located with respect to a projection of longitudinal axis 113 of fastening element 111.

FIG. 10 shows a fourth specific embodiment of a self-tapping fastening element 121 having two diametrically opposed cutting edges 131, each being a part of a U-shaped groove which is radially outwardly open. In this case the grooves are offset with respect to a projection of longitudinal axis 128 of fastening element 121. Cutting edges 131 extend perpendicular to the turn of thread 127.

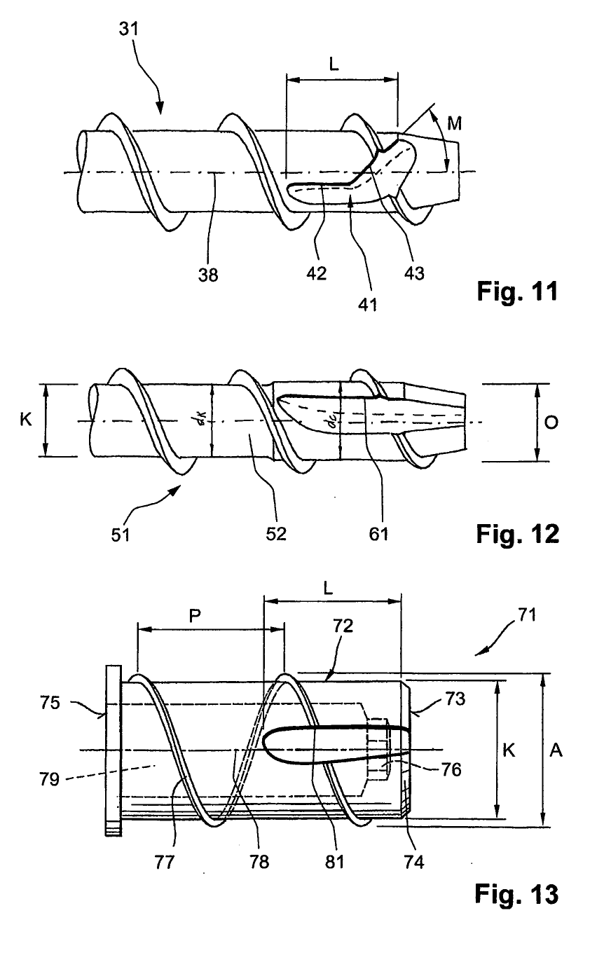

FIG. 11 shows a fifth specific embodiment of a self-tapping fastening element 31, having an alternatively designed cutting edge 41 whose orientation with respect to longitudinal axis 38 of fastening element 31 has a discontinuous design. Cutting edge 41 has a first section 42 which extends essentially paraxially with respect to longitudinal axis 38 of fastening element 31, and a second section 43 which extends at an angle to a projection of longitudinal axis 38. Angle M of second section 43 relative to the projection of longitudinal axis 38 is 20°.

FIG. 12 shows a self-tapping fastening element 51 having a shank 52 which in the first end region, at least in the region of cutting edges 61, has a core diameter O which is larger than remaining core diameter K of shank 52.

FIG. 13 illustrates a self-tapping internally threaded sleeve, having a cylindrical shank 72, as a self-tapping fastening element 71 for mineral components. On a first free end 73, shank 72 has an insertion section 74 which tapers toward free end 73 of shank 12, and a bore hole 79, starting from a second end 75 of shank 72 and having an inner thread. At the base of bore hole 79 a polygonal recess is provided as rotary engagement means 76 for a setting tool, not illustrated. A self-tapping thread 77 extends in places along shank 72, starting from an end region of first end 73, the difference between outer diameter A of thread 77 and core diameter K of shank 72 corresponding to 0.05 to 0.7 times pitch P of thread 77. Shank 72 defines longitudinal axis 78 of fastening element 71. At the first end region of shank 72 one of the at least two cutting edges 81 is illustrated, each having a length L which extends parallel to longitudinal axis 78 of fastening element 71. The summed overall length of the cutting edges extending parallel to longitudinal axis 78 of fastening element 71 corresponds at least to pitch P of thread 77.

What is claimed is:

1. A method for anchoring a fastening element in a mineral component, comprising:
producing a bore hole in the component using a drill bit having a nominal drill bit diameter;
screwing a fastening element into the bore hole produced, the fastening element having a shank provided with a rotary engagement device for a setting tool, the shank having a core diameter and at least one cutting edge on a first end region, and having a self-tapping thread, in which the difference between an outer diameter of the thread and the core diameter of the shank corresponds to 0.05 to 0.7 times a pitch of the thread;
the nominal drill bit diameter corresponding to 0.95 to 1.10 times the core diameter of the shank.

2. The method as recited in claim 1 wherein the nominal drill bit diameter corresponds to 0.99 to 1.08 times the core diameter of the shank.

3. A fastening element for mineral components, comprising:
a shank having a rotary engagement device for a setting tool, and having a self-tapping thread, a difference between an outer diameter of the thread and a core diameter of the shank corresponding to 0.05 to 0.7 times a pitch of the thread, at least one cutting edge being provided on a first end region of the shank, an overall length of the at least one cutting edge parallel to the longitudinal axis of the fastening element and measured at the core diameter corresponding at least to the pitch of the thread.

4. The fastening element as recited in claim 3 wherein the least one cutting edge includes multiple cutting edges on the first end region of the shank, the summed overall length of the cutting edges parallel to the longitudinal axis of the fastening element and measured at the core diameter corresponding at least to the pitch of the thread.

5. The fastening element as recited in claim 3 wherein the at least one cutting edge extends, at least in places, perpendicular to the pitch of the thread.

6. The fastening element as recited in claim 3 wherein the at least one cutting edge projects radially beyond an axial projection of the core diameter of the shank.

7. The fastening element as recited in claim 3 wherein the shank in the first end region, at least in the region of the at least one cutting edge, has a core diameter larger than a remaining core diameter of the shank.

8. The fastening element as recited in claim 6 wherein a clearance angle is provided between the at least one cutting edge and the shank.

9. The fastening element as recited in claim 3 wherein the at least one cutting edge has a negative rake angle.

10. The fastening element as recited in claim 3 wherein the at least one cutting edge has, at least in places, a section which is harder than the shank.
